(19) United States
(12) Patent Application Publication
(10) Pub. No.: US 2023/0242094 A1
(43) Pub. Date: Aug. 3, 2023

(54) HYBRID VEHICLE WITH A PRECHAMBER COMBUSTION ENGINE

(71) Applicants: Hyundai Motor Company, Seoul (KR); Kia Corporation, Seoul (KR)

(72) Inventors: Mayuri Wagh, Superior Township, MI (US); Mark Shirley, Superior Township, MI (US); Nahm Roh Joo, Yongin (KR); Mark Bourcier, Superior Township, MI (US); Antowan Zyada, Superior Township, MI (US); Jeffrey Hollowell, Commerce, MI (US); Philip Zoldak, Superior Township, MI (US)

(21) Appl. No.: 17/589,413

(22) Filed: Jan. 31, 2022

(51) Int. Cl. B60W 20/40; B60K 6/24; B60W 10/06; B60W 10/08; B60W 20/16

(52) U.S. Cl. CPC B60W 20/40; B60K 6/24; B60W 10/06; B60W 10/08; B60W 20/16; B60W 2510/0638; B60W 2710/244; B60W 2510/0657; B60W 2510/083

(57) ABSTRACT

Methods and systems are described for a hybrid vehicle with a passive prechamber combustion engine. The system includes a passive prechamber combustion engine, an electric motor, and a controller communicatively coupled to the combustion engine and the electric motor. The combustion engine is configured to operate at engine loads satisfying a load threshold. The controller is configured to determine whether an engine load falls below the load threshold. The controller is configured to select the electric motor to propel the vehicle. The controller is configured to determine whether the engine load satisfies the load threshold. The controller is configured to select the combustion engine to propel the vehicle for providing efficient fuel consumption associated with prechamber ignition in response to determining that the engine load satisfies the load threshold.

### TECHNICAL FIELD

The present disclosure relates generally to vehicles, and more particularly, to hybrid vehicles having a passive prechamber combustion engine.

### BACKGROUND

Internal combustion engines commonly use an electric spark to ignite fuel inside of a combustion chamber. But engines with spark plugs may not consistently achieve complete combustion because of the slow rate of flame propagation. A passive prechamber may correct the problem of slow rate of flame propagation by providing flame jets into the cylinders of the engine. However, passive prechamber engines have poor performance when pulling low loads and at cold starts.

### SUMMARY

The present disclosure provides methods, systems, articles of manufacture, including computer program products, for hybrid vehicles having a passive prechamber combustion engine.

In one aspect, there is provided a system including a combustion engine, an electric motor, and a controller communicatively coupled to the combustion engine and the electric motor. The combustion engine has a passive prechamber facing a combustion chamber. The combustion engine is configured to operate at engine loads satisfying a load threshold. The passive prechamber is configured to enable prechamber ignition, which provides efficient fuel consumption at higher loads. The electric motor is powered by a battery and configured to operate at engine loads below the load threshold. The controller is configured to determine whether an engine load falls below the load threshold. The controller is configured to select the electric motor to propel the vehicle. The controller is configured to determine whether the engine load satisfies the load threshold. The controller is configured to select the combustion engine to propel the vehicle for providing efficient fuel consumption associated with prechamber ignition in response to determining that the engine load satisfies the load threshold.

In some variations, the controller is further configured to disable the electric motor in response to determining that the engine load satisfies the load threshold. Additionally, the controller is further configured to disable the combustion engine in response to determining the engine load being below the load threshold. In some variations, the controller is further configured to select the electric motor in response to determining an engine speed being below a speed threshold. In some variations, the controller is further configured to determine whether an engine speed satisfies a speed threshold and whether a battery charge is below a charge threshold; and in response to determining the engine speed satisfies the speed threshold and the battery charge is below the charge threshold, enable the combustion engine to charge the battery.

Further, the controller is further configured to determine whether the engine speed is below the speed threshold and whether the battery charge satisfies the charge threshold; and in response to determining the engine speed is below the speed threshold and the battery charge satisfies the charge threshold, select the electric motor to propel the vehicle and disable the combustion engine. In some variations, the controller is further configured to determine whether a vehicle momentum is capable of charging the battery; and in response to determining the vehicle momentum is capable of charging the battery, generate electric power with the electric motor to charge the battery and disable the combustion engine.

In some variations, the controller is further configured to determine whether the engine load satisfies the load threshold; and in response to determining the engine load satisfies the load threshold, selecting direct injection at the combustion engine with multiple delayed timing injections. Additionally, the controller is further configured to determine whether a battery charge is below a charge threshold and whether a torque is required to drive the vehicle; and in response to determining the battery charge is below the charge threshold and the torque is required to drive the vehicle, enable the combustion engine to charge the battery and provide torque to drive the vehicle. Further, the combustion engine has instable combustion at engine loads below the load threshold and wherein the electric motor and the combustion engine are arranged in a series hybrid configuration.

In some variations, the combustion engine has instable combustion at engine loads below the load threshold and wherein the electric motor and the combustion engine are arranged in a parallel hybrid configuration. Additionally, the passive prechamber includes a spark plug, and wherein the passive prechamber is at least one of a supersonic passive prechamber and an air-injected passive prechamber. Further, the combustion engine is at least one of a stoichiometry burn engine with an exhaust gas recirculation system, and a lean-burn combustion engine with an exhaust after-treatment system including a passive selective catalytic reduction system.

Implementations of the current subject matter may include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which may include a non-transitory computer-readable or machine-readable storage medium, may include, encode, store, or the like one or more programs that cause one or more processors to perform one or more of the operations described herein. Computer-implemented methods consistent with one or more implementations of the current subject matter may be implemented by one or more data processors residing in a single computing system or multiple computing systems.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a block diagram of a vehicle with a passive prechamber engine and an electric motor;

FIG. 2 depicts an example of a graph representative of modes of operation for an engine according to engine speed and load;

FIG. 3 depicts an example of a signal diagram for controlling fuel and air delivered to a combustion chamber;

FIG. 4A depicts an example of a diagram illustrating a converging nozzle for a passive prechamber;

FIG. 4B depicts an example of a diagram illustrating a converging-diverging nozzle for a passive prechamber;

FIG. 4C depicts an example of a diagram illustrating a converging-diverging large nozzle for a passive prechamber;

FIG. 4D depicts an example of a diagram illustrating a converging-straight-diverging nozzle for a passive prechamber;

FIG. 4E depicts an example of a diagram illustrating a smooth converging-diverging nozzle for a passive prechamber;

FIG. 5 depicts an example of a flowchart illustrating a selection of a mode of operation for a passive prechamber engine and an electric motor based on a battery charge;

FIG. 6 depicts an example of a configuration of a vehicle with an engine having a prechamber and an electric motor;

FIG. 7A depicts an example of a block diagram of a hybrid vehicle having a drivetrain with an electric motor and a passive prechamber engine and start-stop functionality;

FIG. 7B depicts an example of another block diagram of a hybrid vehicle having a drivetrain with an electric motor and an engine having a prechamber and start-stop functionality;

FIG. 7C depicts an example of yet another block diagram of a hybrid vehicle having a drivetrain with an electric motor and an engine having a prechamber and start-stop functionality;

FIG. 8 depicts an example of a table illustrating two applications of the hybrid prechamber engine configured to operate a vehicle; and

FIG. 9 depicts a block diagram illustrating a computing system consistent with implementations of the current subject matter.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present embodiments may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium may also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

According to the present disclosure, a hybrid vehicle having a passive prechamber internal combustion engine is disclosed. Passive prechambers may boost fuel efficiency by increasing the likelihood that complete combustion occurs in the engine cylinders. The passive prechamber increases the likelihood of complete combustion by solving the problem of slow flame propagation. The passive prechamber uses a secondary volume to provide a locally rich mixture next to the combustion chamber. The locally rich mixture in the passive prechamber may be ejected into the main chamber as high-velocity turbulent flame jets. In some embodiments, the turbulent flame jets may be ejected from multiple orifices.

But a common problem for engines with passive prechambers is poor performance at low loads and cold starts. A passive prechamber combustion engine may not be fuel-efficient or have consistent performance at low loads and at cold temperatures similar to its fuel efficiency and consistent performance at mid to high loads and at steady-state temperatures. As such, the prechamber combustion hybrid vehicle of the present disclosure solves the problem of poor performance at low loads and cold starts by activing an electric motor to operate the vehicle at low loads and cold starts. In turn, the passive prechamber engine may be enabled once a predetermined speed, a predetermined load, or a predetermined temperature is reached. Accordingly, the electric motor may operate at loads/temps where the passive prechamber engine is otherwise limited.

Additionally, emissions from the vehicle may be reduced by using the hybrid electric vehicle with the passive prechamber engine. The hybrid electric motor may power the vehicle at low loads, resulting in fewer emissions. As the engine load is increased, the vehicle may shift to activate the passive prechamber combustion engine. The emissions of the passive prechamber engine are very low compared to an internal combustion engine with no prechamber.

The prechamber combustion hybrid vehicle of the present disclosure also solves the problems associated with active prechambers. For instance, passive prechambers are more fuel-efficient than active prechambers since active prechambers require more fuel compared to passive prechambers. The passive prechamber may also offer better fuel economy as the volume of the passive prechamber is smaller than the active prechamber.

The hybrid vehicle having a passive prechamber combustion engine may require a controller to shift between powering with the passive prechamber engine and powering with the electric motor. The methods, systems, and apparatuses described herein may transition between the passive prechamber engine and the electric motor based on the vehicle speed and load. The various embodiments also operate the electric motor at engine loads below a load threshold.

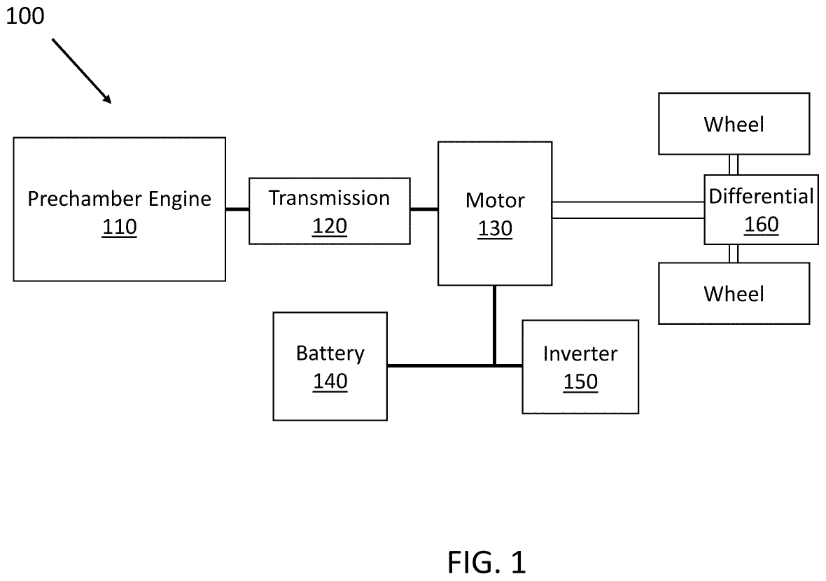

FIG. 1 depicts an example of a block diagram of a vehicle with a passive prechamber engine 110 and an electric motor 130. The passive prechamber engine 110 may be coupled to a transmission 120. The passive prechamber engine 110 may drive the gears in the transmission 120 to propel the vehicle. The transmission 120 may be coupled to an electric motor 130 that is powered by a battery 140 and coupled to an inverter 150. The inverter 150 may transform kinetic energy from the motor 130 to charge the battery 140. The electric motor 130 may power the vehicle. Additionally, and/or alternatively, the passive prechamber engine 110 may power the vehicle. The electric motor 130 and the passive prechamber engine 110 may power the vehicle through the same driveshaft. A differential 160 may be connected to the driveshaft. The driveshaft may transfer power to the wheels through the differential 160.

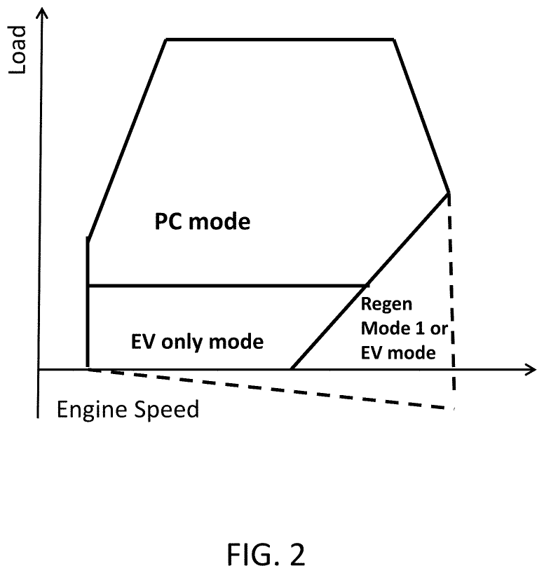

FIG. 2 depicts an example of a graph representative of modes of operation for an engine according to engine speed and load. A controller may be configured to select between different modes of engine operation. The controller may be communicatively coupled to the passive prechamber engine 110 and the electric motor 130. In addition, the controller may be communicatively coupled to a memory storing instructions related to the different modes of operation. The controller may be communicatively coupled to a fuel delivery system, an air boost system, an intake valve at a combustion chamber, an exhaust valve at a combustion chamber. The controller may be communicatively coupled to a device configured to send a data reading satisfying a load threshold indicating that the vehicle is to be propelled by the passive prechamber engine 110 instead of the electric motor 130.

Further, the controller may be communicatively coupled to various sensors at the combustion engine, such as an engine speed sensor, an engine temperature sensor, and an engine load sensor. The engine speed sensor may be configured to detect the speed of the engine in revolutions per minute. The engine temperature sensor may be configured to detect the temperature of the engine and, more specifically, the oil temperature in the engine. The engine load sensor may be configured to detect a torque at the engine output and/or a revolutions per minute at the engine.

The controller may be configured to select an operation mode based on data readings from the engine speed sensor. For example, the controller may be configured to select an electric motor mode based on the data readings from the engine speed sensor having an engine speed value less than a predetermined engine speed value. The controller may be configured to select an electric motor mode based on data readings from the engine temperature sensor. For example, the controller may be configured to select a prechamber combustion mode based on the data readings from the engine temperature sensor having an engine temperature value greater than a predetermined engine temperature value. The controller may be configured to select an engine combustion mode based on data readings from the engine load sensor. For example, the controller may be configured to select a prechamber combustion mode based on data readings from the engine load sensor being greater than a predetermined engine torque value.

Additionally, the controller may be configured to select an electric motor mode. The electric motor mode may include instructions to apply battery power to the electric motor 130 to propel the vehicle. The electric motor mode may be selected based on the passive prechamber engine 110 being lower than a predetermined temperature. The electric motor mode may be selected based on low load conditions on the passive prechamber engine 110 and the passive prechamber engine 110 temperature falling below a threshold engine temperature. The low load conditions may be indicative of an engine speed being less than a predetermined engine speed or an engine torque less than a predetermined engine torque.

The controller may be configured to select a prechamber combustion mode. The prechamber combustion mode may include instructions to propel the vehicle using the passive prechamber engine 110. The prechamber combustion mode may be selected based on load conditions satisfying a predetermined load threshold. Additionally, and/or alternatively, prechamber combustion mode may be selected based on the engine temperature satisfying a threshold engine temperature. The higher load conditions may be indicative of an engine speed greater than a predetermined engine speed and/or an engine torque greater than a predetermined engine torque.

When transitioning from the electric motor mode to the prechamber combustion mode, the controller may be configured to shut off the electric motor 130 and turn on the passive prechamber engine 110. The controller may further enable the boost, the exhaust gas recirculation system, and the 50/50 split direct injection while using multiple injections with late timing. When transitioning from the prechamber combustion mode to the electric motor mode, the controller may be configured to turn on the electric motor 130 and shut off the passive prechamber engine 110. The controller may be configured to transition from the prechamber combustion mode to the electric motor mode when the battery charge decreases below a threshold.

In some embodiments, the controller may be configured to operate the prechamber combustion mode and the electric motor mode simultaneously. The controller may be configured to turn on the electric motor 130 to work along with the passive prechamber engine 110. For example, the controller may be configured to instruct the passive prechamber engine 110 to provide up to about 70% of the power while the electric motor 130 provides about 30% of the power. The controller may be configured to shut off the electric motor 130 to operate the prechamber combustion mode.

Further, the controller may be configured to select an engine-on regeneration mode. The engine-on regeneration mode may include instructions to maintain the passive prechamber engine 110 on to charge the battery 140 with the drive torque. Additionally, the engine-on regeneration mode may be selected by the controller based on high load conditions and to charge the battery 140 with the drive torque. The high load conditions may be indicative of an engine speed being greater than a predetermined engine speed or an engine torque being greater than a predetermined engine torque. The engine-on regeneration mode may charge the battery 140 if the battery charge is low (e.g., less than a threshold). The engine-on regeneration mode may be selected to charge the battery 140 when the passive prechamber engine 110 is not propelling the vehicle. If the battery 140 is sufficiently charged, the electric motor mode may be selected instead.

When transitioning to the engine-on regeneration mode, the passive prechamber engine 110 may continue operating and apply power to the electric motor 130 such that the electric motor 130 becomes a generator to charge the battery 140. When transitioning from the engine-on regeneration mode to the electric motor mode, the controller may be configured to turn off the passive prechamber engine 110 and enable the electric motor 130 to generate energy instead of consuming it.

Further, the controller may be configured to select an engine-off regeneration mode. The engine-off regeneration mode may include instructions to cut fuel to the passive prechamber engine 110 while charging the battery 140 using the momentum of the vehicle. The momentum from the vehicle may cause the electric motor 130 to act as a generator to power the battery 140. The controller may be configured to select the engine-off regeneration mode based on vehicle deceleration. The vehicle deceleration may be indicative of the driver applying the brake or an engine speed decreasing at a predetermined deceleration rate. The engine-off regeneration mode may charge the battery 140 using the momentum of the vehicle rather than power from the passive prechamber engine 110.

When transitioning from the engine-on regeneration mode to the engine-off regeneration mode, the controller may be configured to shut off the passive prechamber engine 110. The controller may also enable the electric motor 130 to generate electric power to charge the battery 140. When transitioning from an engine-off regeneration mode to an electric motor mode, the controller may enable the electric motor 130 to consume electric power rather than generating electric power.

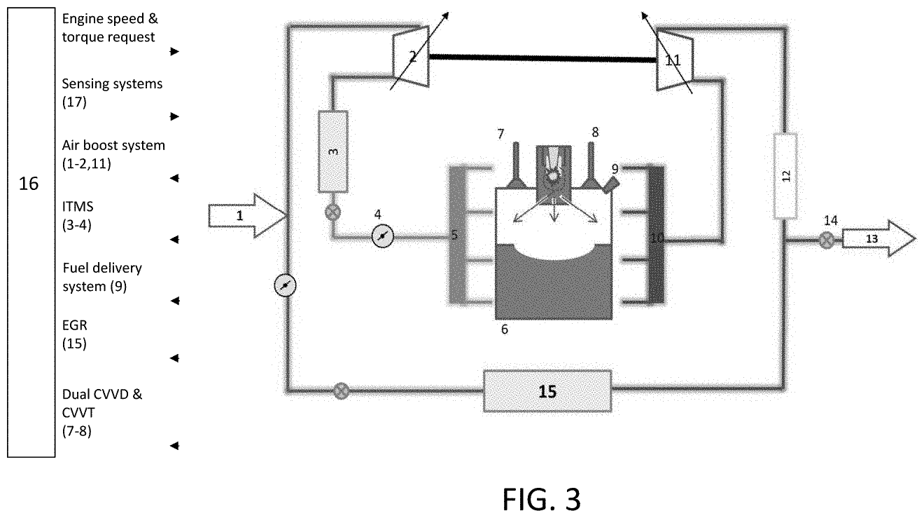

FIG. 3 depicts an example of a signal diagram for controlling fuel and air delivered to a combustion chamber. The signal diagram maps an air boost system, an intake air management system, an exhaust gas recirculation system, a continuous variable valve duration mechanism, a continuous variable valve timing mechanism, a combustion chamber, a fuel delivery system, and a controller. The controller may be communicatively coupled to the air boost system, the intake air management system, the exhaust gas recirculation system, the continuous variable valve duration mechanism, the continuous variable valve timing mechanism, the combustion chamber, and the fuel delivery system to send instructions to a component based on the mode of operation.

The passive prechamber engine 110 may be an engine chamber with a combustion chamber with multiple cylinders. The engine may have a compression ratio of 10:1 or greater. Each cylinder in the passive prechamber engine 110 may have direct fuel injection and have a passive prechamber directly facing its respective combustion chamber. The electronic control unit (ECU) may be configured to operate the spark plugs in each passive prechamber. The exhaust gas recirculation system may have continuous variable valve duration and/or continuous variable valve timing mechanisms for intake and exhaust valves.

The controller may be configured to transmit instructions to the air boost system for operation thereof. The air boost system may include a turbocharger. The turbocharger may be a single-stage turbocharger or some combination of turbocharger (e.g., dual turbocharger system, or a mechanical or electrical supercharger). The air boost system may be configured to receive exhaust from the engine and recirculate the air intake back into the combustion engine. The controller may be configured to operate the air boost system to increase the air delivered to the combustion chamber.

The controller may be configured to transmit instructions to the intake air management system for operation thereof. The intake air management system may be configured to adjust the amount of air delivered to the compression chamber. An increase in the air delivered to the compression chamber creates a leaner fuel-to-air mixture. The intake air management system may include a dual charge air heater and air cooler. The controller may be configured to operate the intake air management system to increase the air delivered to the combustion chamber.

The controller may be configured to transmit instructions to the continuous variable valve duration mechanism for operation thereof. The continuous variable valve duration mechanism may be configured to adjust the duration and timing of intake and exhaust valves based on the instructions from the controller. The controller may be configured to operate the continuous variable valve duration mechanism to decrease the intake valve open duration and the exhaust valve open duration such that a time delay exists between the intake valve duration and the exhaust valve open duration. Additionally, the controller may be configured to transmit instructions to the continuous variable valve timing mechanism. The controller may be configured to operate the continuous variable valve timing mechanism to extend the intake valve open duration and the exhaust valve open duration such that the intake valve duration and the exhaust valve open duration overlap in time.

Further, the controller may be configured to transmit instructions to the fuel delivery system for operation thereof. The fuel delivery system may include a high-pressure direct injector and a low-pressure fuel injector in the combustion chamber. The controller may be configured to interrupt a fuel supply at the fuel delivery system or increase a fuel supply at the fuel delivery system.

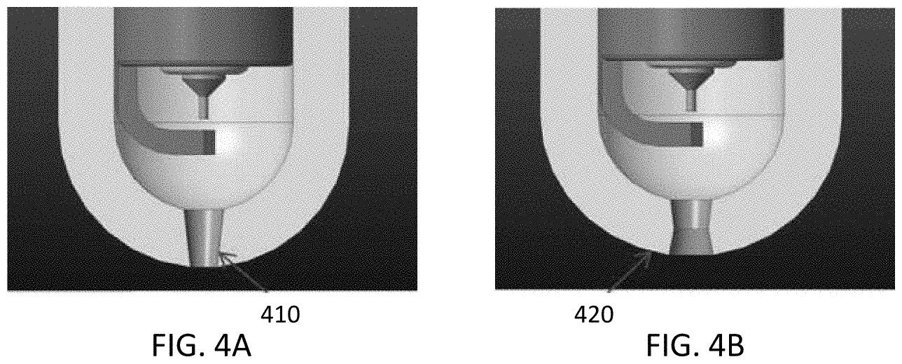

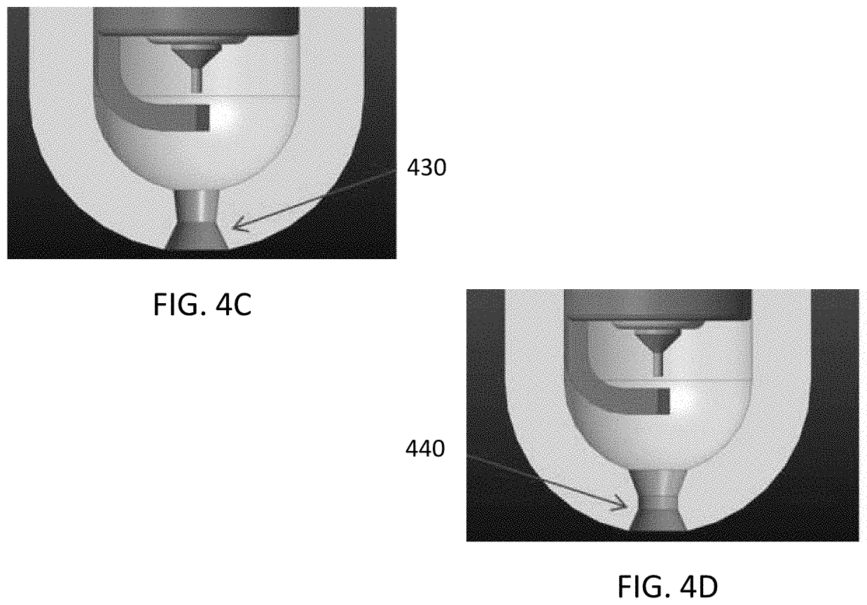

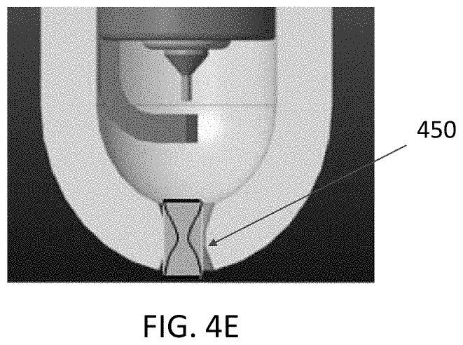

FIG. 4A depicts an example of a diagram illustrating a converging nozzle 410 for a passive prechamber. The converging nozzle 410 may taper from the top side to the bottom side. The converging nozzle 410 may be wider at the opening at the passive prechamber than the opening at the combustion cylinder. The converging nozzle geometry may support some low load performance and may maintain expected efficiency benefits at a partial vehicle load.

FIG. 4B depicts an example of a diagram illustrating a converging-diverging nozzle 420 for a passive prechamber. The converging-diverging nozzle 420 may taper from the top side to the middle of the nozzle. The converging-diverging nozzle 420 may expand from the middle of the nozzle to the bottom side of the nozzle. The converging-diverging nozzle 420 may have an opening that is about the same width at the passive prechamber as the opening at the combustion cylinder. The converging-diverging nozzle geometry may support some low load performance and may maintain expected efficiency benefits at a partial vehicle load.

FIG. 4C depicts an example of a diagram illustrating a converging-diverging large nozzle 430 for a passive prechamber. The converging-diverging large nozzle 430 may taper from the top side to a middle section of the nozzle. The converging-diverging large nozzle 430 may expand from the middle of the nozzle to the bottom side of the nozzle. The converging-diverging large nozzle 430 may have an opening that is a smaller width at the passive prechamber than the opening at the combustion cylinder. In other words, the converging-diverging large nozzle 430 may be wider at the passive prechamber opening than the combustion cylinder opening. The converging-diverging large nozzle geometry may support some low load performance and may maintain expected efficiency benefits at a partial vehicle load.

FIG. 4D depicts an example of a diagram illustrating a converging-straight-diverging nozzle 440 for a passive prechamber. The converging-straight-diverging nozzle 440 may taper from the top side to the middle of the nozzle. The converging-straight-diverging nozzle 440 may have a section that runs straight (no angles) towards the bottom side of the nozzle. The converging-straight-diverging nozzle 440 may expand from the middle section of the nozzle to the bottom side of the nozzle. The converging-straight-diverging nozzle 440 may have an opening that is the same width at the passive prechamber as the opening at the combustion cylinder. That is, the converging-straight-diverging nozzle 440 may be the same width at the passive prechamber opening as the combustion cylinder opening. The converging-straight-diverging nozzle geometry may support some low load performance and may maintain expected efficiency benefits at a partial vehicle load.

FIG. 4E depicts an example of a diagram illustrating a smooth converging-diverging nozzle 450 for a passive prechamber. The smooth converging-diverging nozzle 450 may have an hourglass shape. The smooth converging-diverging nozzle 450 may taper from the top side to the middle of the nozzle. The smooth converging-diverging nozzle 450 may expand from the middle section of the nozzle to the bottom side of the nozzle. The smooth converging-diverging nozzle 450 may have an opening that is the same width at the passive prechamber as the opening at the combustion cylinder. In other words, the smooth converging-diverging nozzle 450 may be the same width at the passive prechamber opening as the combustion cylinder opening. The smooth converging-diverging nozzle 450 geometry may support some low load performance and may maintain expected efficiency benefits at a partial vehicle load.

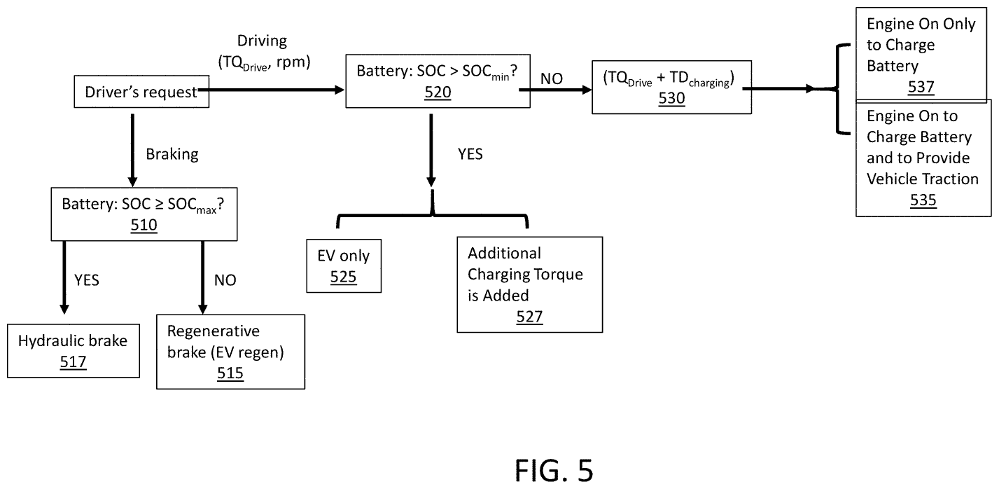

FIG. 5 depicts an example of a flowchart illustrating a selection of a mode of operation for a passive prechamber engine 110 and an electric motor 130 based on a battery charge. The combustion engine may have a passive prechamber facing a combustion chamber. The prechamber engine 110 may be configured to operate at engine loads satisfying a load threshold. The passive prechamber may be configured to enable prechamber ignition with efficient fuel consumption at higher loads. The electric motor 130 may be powered by a battery 140. The electric motor 130 may be configured to operate at engine loads below the load threshold. The controller may be communicatively coupled to the prechamber engine 110 and the electric motor 130.

At 510, the controller may be configured to detect that the braking is applied. In response to detecting that braking is applied, the controller may be configured to determine whether the battery charge satisfies a predetermined charge threshold. For example, the controller may be configured to determine that the battery charge is equal to or greater than about 13 volts. In another example, the controller may be configured to determine that the battery charge is greater than a predetermined number of coulombs. In yet another example, the controller may be configured to determine that the battery charge is not sufficient to crank the engine.

At 515, the controller may be configured to activate a regenerative brake in response to determining the battery charge does not satisfy a predetermined charge threshold. The regenerative brake may harness the momentum of the vehicle to recharge the battery 140. The regenerative brake may use the electric motor 130 as a power generator. The regenerative brake may use the power generated by the electric motor 130 to recharge the battery 140 via the inverter 150. At 517, in some embodiments, the controller may be configured to activate the hydraulic brake in response to determining the battery charge satisfies the predetermined charge threshold.

At 520, the controller may be configured to detect that the vehicle is driving and that the battery charge satisfies a predetermined charge threshold. At 525, in response to detecting that the vehicle is driving and that the battery charge satisfies the predetermined charge threshold, the controller may be configured to determine to propel the vehicle using the electric motor 130. At 527, the controller may be configured to continue propelling the vehicle using the electric motor 130 while the battery charge threshold is satisfied and additional charging torque is added.

In some embodiments, the controller may be configured to determine that the battery charge is lower than a maximum charge threshold. In response to detecting that the battery charge is lower than the maximum charge threshold, the controller may be configured to select the passive prechamber engine 110 to propel the vehicle while providing additional charging torque for the battery 140. That is, the controller may be configured to select a mode of operation using the passive prechamber engine 110 to charge the battery 140 to the maximum threshold.

At 530, the controller may be configured to detect that the vehicle is driving and that the battery charge does not satisfy a predetermined charge threshold. In response to detecting that the vehicle is driving and that the battery charge does not satisfy a predetermined charge threshold, the controller may be configured to select the passive prechamber engine 110 to propel the vehicle. At 535, the passive prechamber engine 110 may charge the battery 140 and propel the vehicle forward. At 537, in some embodiments, the passive prechamber engine 110 may only be on to charge the battery 140.

In some embodiments, the controller may be further configured to disable the electric motor 130 in response to determining that the engine load satisfies the load threshold. Additionally, the controller may be further configured to disable the prechamber engine 110 in response to determining the engine load being below the load threshold. In some variations, the controller may be further configured to select the electric motor 130 in response to determining an engine speed being below a speed threshold. In some variations, the controller may be further configured to determine whether an engine speed satisfies a speed threshold and whether a battery charge is below a charge threshold. In response to determining the engine speed satisfies the speed threshold and the battery charge is below the charge threshold, the controller may enable the prechamber engine 110 to charge the battery 140.

Further, the controller may be further configured to determine whether the engine speed is below the speed threshold and whether the battery charge satisfies the charge threshold. In response to determining the engine speed is below the speed threshold and the battery charge satisfies the charge threshold, the controller may be configured to select the electric motor 130 to propel the vehicle and disable the prechamber engine 110. In some variations, the controller may be further configured to determine whether a vehicle momentum is capable of charging the battery 140; and in response to determining the vehicle momentum is capable of charging the battery 140, the controller may generate electric power with the electric motor 130 to charge the battery 140 and disable the prechamber engine 110.

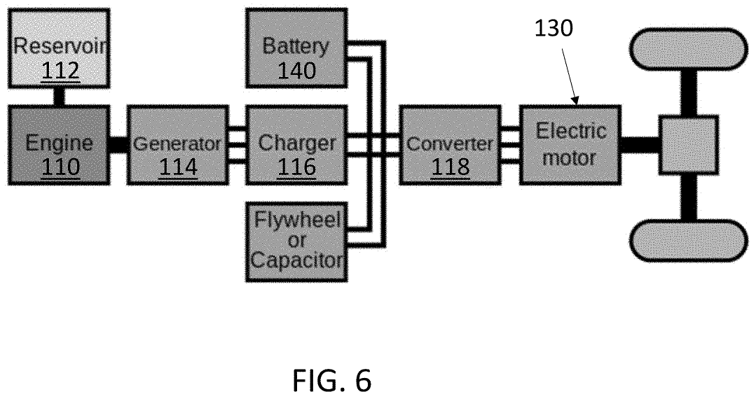

FIG. 6 depicts an example of a configuration of a hybrid vehicle with a passive prechamber engine 110 and an electric motor 130. In some configurations, the passive prechamber engine 110 may be integrated into the hybrid vehicle. The passive prechamber engine 110 may be configured to extend the range of the hybrid vehicle. The passive prechamber engine 110 may be configured to operate at larger loads and once the engine reaches a predetermined threshold.

The passive prechamber engine 110 may be coupled to a reservoir with fuel. The passive prechamber engine 110 may be coupled to a generator to generate electric power. The generator may be connected to a charger to regulate the power from the generator and to charge the battery 140. The charger may be coupled to a converter to power the electric motor 130. The converter may step up (increase) the voltage or the converter may step down (decrease) the voltage for the electric motor 130. The electric motor 130 may be coupled to a driveshaft and may power the vehicle. Additionally, and/or alternatively, the passive prechamber engine 110 may power the vehicle. The electric motor 130 and the passive prechamber may power the vehicle through the same driveshaft. A differential 160 may be connected to the driveshaft. The driveshaft may transfer power to the wheels through the differential 160.

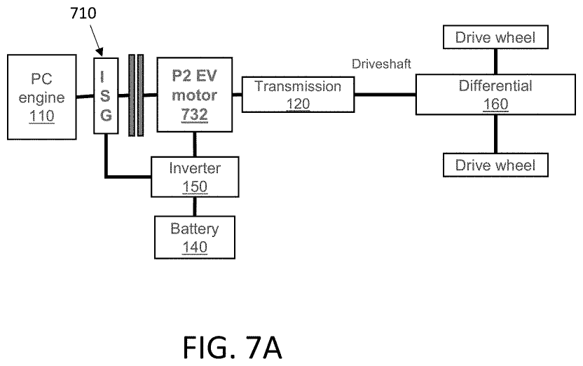

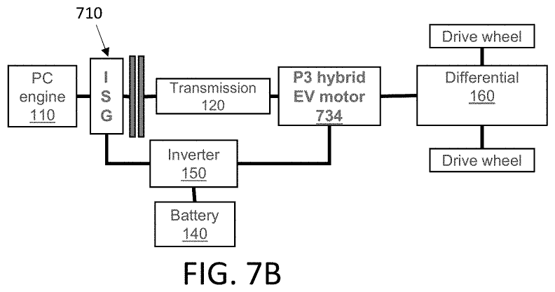

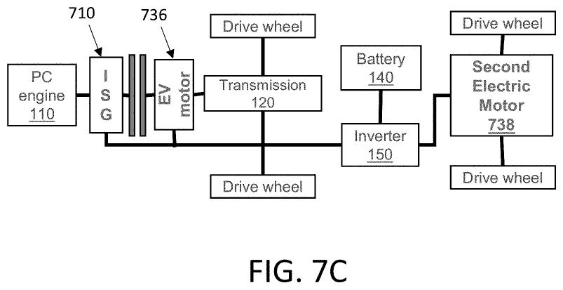

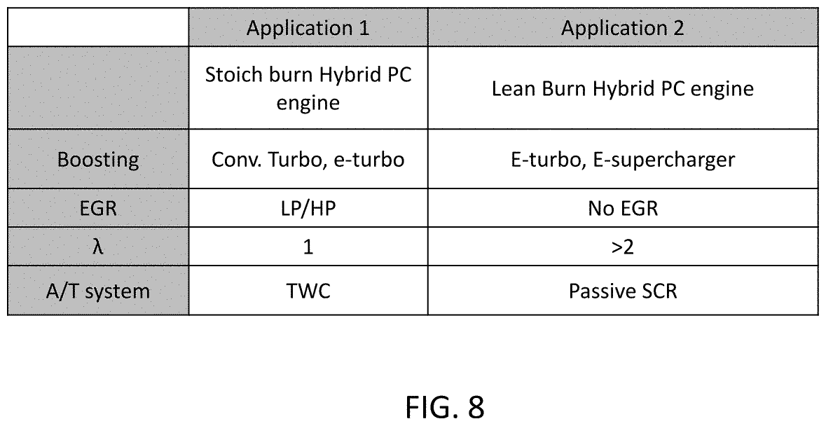

FIG. 7A depicts an example of a block diagram of a hybrid vehicle having a drivetrain with a P2hybrid motor 732 and a passive prechamber engine 110 and start-stop functionality. The passive prechamber engine 110 may have start-stop functionality. Idle Stop and Go (ISG) technology 710 may be used with internal combustion engines to manage fuel consumption. The ISG technology 710 may turn off the vehicle when the vehicle comes to a stop to reduce fuel consumption. The ISG technology 710 may turn the vehicle back on once a vehicle operator disengages the brake pedal or when a particular driving condition is satisfied. The start-stop functionality may be coupled to an inverter 150. The inverter 150 may transform kinetic energy from the P2 hybrid motor 732 to charge the battery 140. The battery 140 may power the electric motor 130 and the P2 hybrid motor 732 may be connected to a gearbox. In particular, the gearbox may be connected to a driveshaft and the driveshaft may be connected to an axle. The driveshaft may transfer power to the wheels through the axle. The P2 hybrid motor 732 and the passive prechamber engine 110 may power the vehicle through the same driveshaft.

FIG. 7B depicts an example of another block diagram of a hybrid vehicle having a drivetrain with a P3 hybrid motor 734 and an engine having a prechamber and start-stop functionality. The passive prechamber engine 110 may have start-stop functionality. The start-stop functionality may be coupled to an inverter 150 configured to transform kinetic energy from the P3 hybrid motor 734 to charge the battery 140. The battery 140 may power the electric motor 130 and the power from the battery 140 to the P3 hybrid motor 734 may pass through the inverter 150. The electric motor 130 may be connected to a gearbox. The P3 hybrid motor 734 may be connected to a driveshaft connected to an axle. The driveshaft may transfer power to the wheels through the axle. The P3 hybrid motor 734 and the passive prechamber engine 110 may power the vehicle through the same driveshaft.

FIG. 7C depicts an example of yet another block diagram of a hybrid vehicle having a drivetrain with an electric motor 130 and an engine having a prechamber and start-stop functionality. The passive prechamber engine 110 may have start-stop functionality. A clutch may connect the driveshaft to the gearbox of the drive wheels. The start-stop functionality may be coupled to an inverter 150. The inverter 150 may transform kinetic energy from the motor 130 to charge the battery 140. The battery 140 may power a first electric motor 736 and a second electric motor 738. The first electric motor 736 may drive the front wheels of the vehicle and the second electric motor 738 may drive the back wheels of the vehicle. The first electric motor 736 may be connected to the same driveshaft as the passive prechamber engine 110. The first electric motor 736 may be situated between the clutch and the gearbox.

The first electric motor 736 may be coupled to a gearbox for the first axle to drive the front wheels. The second electric motor 738 may be situated between the second axle to drive the back wheels. The power from the battery 140 to the first electric motor 736 and/or the second electric motor 738 may pass through the inverter 150. The first electric motor 736 and/or the second electric motor 738 may be connected to a gearbox. The first electric motor 736 and/or the second electric motor 738 may be connected to a driveshaft. The driveshaft may be connected to an axle and may transfer power to the front wheels and/or back wheels through the axle. The first electric motor 736 and/or the second electric motor 738 and the passive prechamber may be power the vehicle through the same driveshaft.

FIG. 8 depicts an example of a table illustrating two applications of the hybrid prechamber engine 110 configured to operate a vehicle. A hybrid vehicle powertrain may have two different powertrains: stoichiometry burn hybrid passive prechamber engine 110 and lean-burn hybrid passive prechamber engine 110. The stoichiometry burn hybrid passive prechamber engine 110 may have an exhaust gas recirculation system. The stoichiometry burn hybrid passive prechamber engine 110 may include a cooler and a system that allows operation at reduced brake specific fuel consumption points of increased exhaust gas dilution.

The lean-burn hybrid passive prechamber engine 110 may operate at lambda greater than two and may be combined with an electric motor 130 for low load operations. In addition, the lean-burn hybrid passive prechamber engine 110 may include an exhaust after-treatment system that includes passive SCR for NOx reduction. The engine may include an e-turbocharger or an e-supercharger for improved fuel efficiency and reduced emissions.

In some variations, the controller may be further configured to determine whether the engine load satisfies the load threshold. In response to determining the engine load satisfies the load threshold, the controller may select direct injection at the prechamber engine 110 with multiple delayed timing injections. Additionally, the controller may be further configured to determine whether a battery charge is below a charge threshold and whether a torque is required to drive the vehicle. In response to determining the battery charge is below the charge threshold and the torque is required to drive the vehicle, the controller may enable the prechamber engine 110 to charge the battery 140 and provide torque to drive the vehicle. Further, the prechamber engine 110 may have instable combustion at engine loads below the load threshold and wherein the electric motor 130 and the prechamber engine 110 are arranged in a series hybrid configuration.

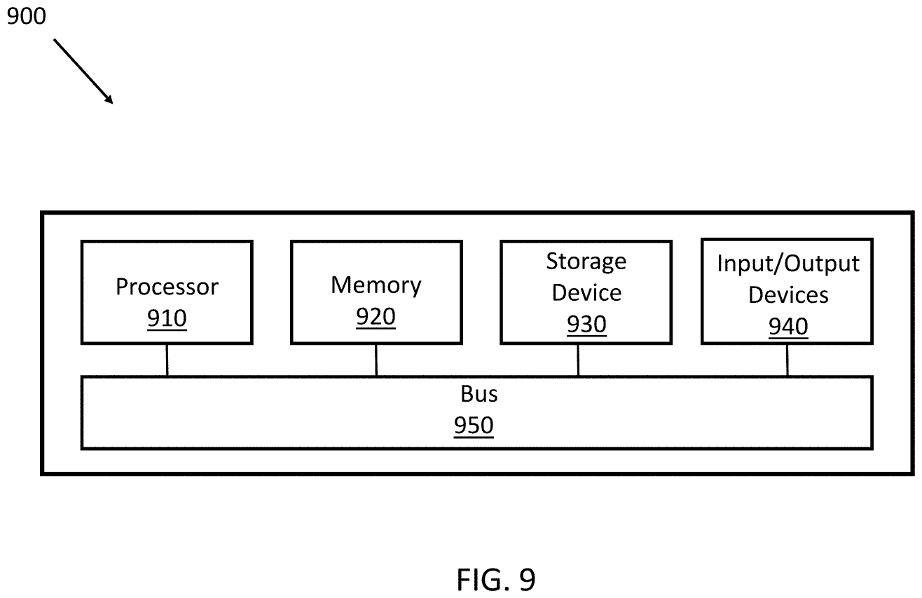

FIG. 9 depicts a block diagram illustrating a computing system 900 consistent with implementations of the current subject matter. Referring to FIGS. 1-9, the computing system 900 may be used to select between different combustion modes. For example, the computing system 900 may implement a user equipment, a personal computer, or a mobile device.

As shown in FIG. 9, the computing system 900 may include a processor 910, a memory 920, a storage device 930, and an input/output device 940. The processor 910, the memory 920, the storage device 930, and the input/output device 940 may be interconnected via a system bus 950. The processor 910 is capable of processing instructions for execution within the computing system 900. Such executed instructions may implement one or more components of, for example, a controller for switching between modes of operation for propelling a vehicle with a passive prechamber engine or an electric motor. In some example embodiments, the processor 910 may be a single-threaded processor. Alternately, the processor 910 may be a multi-threaded processor. The processor 910 is capable of processing instructions stored in the memory 920 and/or on the storage device 930 to display graphical information for a user interface provided via the input/output device 940.

The memory 920 is a non-transitory computer-readable medium that stores information within the computing system 900. The memory 920 may store data structures representing configuration object databases, for example. The storage device 930 is capable of providing persistent storage for the computing system 900. The storage device 930 may be a floppy disk device, a hard disk device, an optical disk device, or a tape device, or other suitable persistent storage means. The input/output device 940 provides input/output operations for the computing system 900. In some example embodiments, the input/output device 940 includes a keyboard and/or pointing device. In various implementations, the input/output device 940 includes a display unit for displaying graphical user interfaces.

According to some example embodiments, the input/output device 940 may provide input/output operations for a network device. For example, the input/output device 940 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 900 may be used to execute various interactive computer software applications that may be used for organization, analysis and/or storage of data in various formats. Alternatively, the computing system 900 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 940. The user interface may be generated and presented to a user by the computing system 900 (e.g., on a computer screen monitor, etc.).

The technical advantages presented herein solve increases fuel efficiency over typical combustion engines by combining a passive prechamber engine with an electric motor. The controller solves the problem of poor performance of the passive prechamber engine at low loads and cold starts by activing an electric motor to operate the vehicle at low loads and cold starts. In turn, the passive prechamber engine may be enabled once a predetermined speed, a predetermined load, or a predetermined temperature is reached. Accordingly, the electric motor may operate at loads/temps where the passive prechamber engine is otherwise limited. The emissions of the passive prechamber engine are very low compared to an internal combustion engine with no prechamber.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A vehicle system comprising:
a combustion engine having a passive prechamber facing a combustion chamber, the combustion engine configured to operate at engine loads satisfying a load threshold, the passive prechamber configured to enable prechamber ignition with efficient fuel consumption at higher loads;
an electric motor powered by a battery, the electric motor configured to operate at engine loads below the load threshold; and
a controller communicatively coupled to the combustion engine and the electric motor, the controller configured to:
determine whether an engine load falls below the load threshold;
in response to determining the engine load falls below the load threshold, select the electric motor to propel a vehicle;
determine whether the engine load satisfies the load threshold; and
in response to determining that the engine load satisfies the load threshold, select the combustion engine to propel the vehicle for providing efficient fuel consumption associated with prechamber ignition.

2. The vehicle system of claim 1, wherein the controller is further configured to:
disable the electric motor in response to determining that the engine load satisfies the load threshold.

3. The vehicle system of claim 1, wherein the controller is further configured to:
disable the combustion engine in response to determining the engine load being below the load threshold.

4. The vehicle system of claim 1, wherein the controller is further configured to:
select the electric motor in response to determining an engine speed being below a speed threshold.

5. The vehicle system of claim 1, wherein the controller is further configured to:
determine whether an engine speed satisfies a speed threshold and whether a battery charge is below a charge threshold; and
in response to determining the engine speed satisfies the speed threshold and the battery charge is below the charge threshold, enable the combustion engine to charge the battery.

6. The vehicle system of claim 5, wherein the controller is further configured to:
determine whether the engine speed is below the speed threshold and whether the battery charge satisfies the charge threshold; and
in response to determining the engine speed is below the speed threshold and the battery charge satisfies the charge threshold, select the electric motor to propel the vehicle and disable the combustion engine.

7. The vehicle system of claim 5, wherein the controller is further configured to:
determine whether a vehicle momentum is capable of charging the battery; and
in response to determining the vehicle momentum is capable of charging the battery, generate electric power with the electric motor to charge the battery and disable the combustion engine.

8. The vehicle system of claim 1, wherein the controller is further configured to:
determine whether the engine load satisfies the load threshold; and
in response to determining the engine load satisfies the load threshold, selecting direct injection at the combustion engine with multiple delayed timing injections.

9. The vehicle system of claim 1, wherein the controller is further configured to:
determining whether a battery charge is below a charge threshold and whether a torque is required to drive the vehicle; and
in response to determining the battery charge is below the charge threshold and the torque is required to drive the vehicle, enable the combustion engine to charge the battery and provide torque to drive the vehicle.

10. The vehicle system of claim 1, wherein the combustion engine has instable combustion at engine loads below the load threshold and wherein the electric motor and the combustion engine are arranged in a series hybrid configuration.

11. The vehicle system of claim 1, wherein the combustion engine has instable combustion at engine loads below the load threshold and wherein the electric motor and the combustion engine are arranged in a parallel hybrid configuration.

12. The vehicle system of claim 1, wherein the passive prechamber includes a spark plug, and wherein the passive prechamber is at least one of a supersonic passive prechamber and an air-injected passive prechamber.

13. The vehicle system of claim 1, wherein the combustion engine is at least one of a stoichiometry burn engine with an exhaust gas recirculation system, and a lean-burn combustion engine with an exhaust after-treatment system including a passive selective catalytic reduction system.

14. A non-transitory computer-readable storage medium storing instructions that, when executed by a processor, cause the processor to perform operations comprising:
determine whether an engine load falls below a load threshold;
in response to determining the engine load falls below the load threshold, select an electric motor to propel a vehicle based on the engine load being below the load threshold, the electric motor powered by a battery and configured to operate at engine loads below the load threshold;
determine whether the engine load satisfies the load threshold; and
in response to determining that the engine load satisfies the load threshold, select a combustion engine to propel the vehicle for providing efficient fuel consumption associated with prechamber ignition, the combustion engine having a passive prechamber facing a combustion chamber and configured to operate at engine loads satisfying the load threshold, the passive prechamber configured to enable prechamber ignition with efficient fuel consumption at higher loads.

15. The non-transitory computer-readable storage medium of claim 14, wherein the operations further comprise:
disable the electric motor in response to determining that the engine load satisfies the load threshold.

16. The non-transitory computer-readable storage medium of claim 14, wherein the operations further comprise:
disable the combustion engine in response to determining the engine load being below the load threshold.

17. The non-transitory computer-readable storage medium of claim 14, wherein the operations further comprise:
select the electric motor in response to determining an engine speed being below a speed threshold.

18. The non-transitory computer-readable storage medium of claim 14, wherein the operations further comprise:
determine whether an engine speed satisfies a speed threshold and whether a battery charge is below a charge threshold; and
in response to determining the engine speed satisfies the speed threshold and the battery charge is below the charge threshold, enable the combustion engine to charge the battery.

19. The non-transitory computer-readable storage medium of claim 18, wherein the operations further comprise:
determine whether the engine speed is below the speed threshold and whether the battery charge satisfies the charge threshold; and
in response to determining the engine speed is below the speed threshold and the battery charge satisfies the charge threshold, select the electric motor to propel the vehicle and disable the combustion engine.

20. A method comprising:
determining whether an engine load falls below a load threshold;
in response to determining the engine load falls below the load threshold, selecting an electric motor to propel a vehicle based on the engine load being below the load threshold, the electric motor powered by a battery and configured to operate at engine loads below the load threshold;
determining whether the engine load satisfies the load threshold; and
in response to determining that the engine load satisfies the load threshold, selecting a combustion engine to propel the vehicle for providing efficient fuel consumption associated with prechamber ignition, the combustion engine having a passive prechamber facing a combustion chamber and configured to operate at engine loads satisfying the load threshold, the passive prechamber configured to enable prechamber ignition with efficient fuel consumption at higher loads.
